(19) United States
(12) Patent Application Publication
(10) Pub. No.: US 2021/0347363 A1
(43) Pub. Date: Nov. 11, 2021

(54) CAR AND METHOD FOR DETECTING ROAD CONDITION AND WARNING FOLLOWING VEHICLE

(71) Applicant: SOUTHERN TAIWAN UNIVERSITY OF SCIENCE AND TECHNOLOGY, Tainan City (TW)

(72) Inventors: CHING-CHOU TANG, TAINAN CITY (TW); YU-CHI HSIEH, TAINAN CITY (TW); KUN-YU LI, TAINAN CITY (TW); JHIH-DENG HONG, TAINAN CITY (TW); LIANG-CHI DAI, TAINAN CITY (TW); SHENG-KAI HUANG, TAINAN CITY (TW); QING-YUAN HUANG, TAINAN CITY (TW); JUI-CHENG KAO, TAINAN CITY (TW)

(21) Appl. No.: 16/867,853

(22) Filed: May 6, 2020

(51) Int. Cl. B60W 40/04; B60W 30/18; B60Q 1/52; B60K 35/00; G06K 9/00

(52) U.S. Cl. CPC B60W 40/04; B60W 30/18018; B60Q 1/525; B60K 35/00; B60K 2370/785; B60W 2554/406; B60K 2370/178; B60K 2370/1868; G06K 9/00825

(57) ABSTRACT

A car and a method for detecting a road condition and warning a following vehicle are provided. The car includes a vehicle body, a road condition detection unit, a processing unit, and a display unit. The road condition detection unit is disposed on the vehicle body. The road condition detection unit is configured to detect the road condition in front of the vehicle body and generate a road condition signal. The processing unit is disposed on the vehicle body and configured to generate a display signal after receiving the road condition signal. The display unit is disposed on a rear windshield of the vehicle body and configured to generate a warning image after receiving the display signal, so as to warn a driver of the following vehicle of the road condition in front of the vehicle body.

### FIELD OF THE INVENTION

The present invention relates to a car and a method for detecting a road condition and warning a following vehicle. The car provides a road condition detection unit for transmitting the road condition in front of the car to a display unit through a processing unit. The display unit is the rear windshield of the car. A warning image is displayed on the rear windshield to warn the driver of the following vehicle.

### BACKGROUND OF THE INVENTION

The main sources of traffic information in Taiwan are real-time road condition reports from Police Radio Stations and the intelligent provincial highway real-time information service network of Directorate General of Highways. The main operation mode is to rely on the technical personnel to actively report and enthusiastic people to actively report the road conditions. However, the main disadvantages are as follows: (1) It mainly reports the traffic conditions for major roads, such as national roads, expressways, and provincial roads. For some roads such as county roads, rural roads, lanes, and mountain roads, there is less reporting or insufficient data. (2) The information query method is mainly described in terms of columns. But, for some drivers that use navigation software, the above information is not integrated into the path planning considerations of the vehicle-mounted navigation software, which makes it impossible to provide real-time traffic information and route planning for the drivers to further save driving time and energy consumption. (3) In general, the enthusiastic people mainly report road conditions by phone. However, not everyone is willing to call and report real-time road conditions to Police Radio Stations. The main problem is that drivers can't immediately know real-time driving conditions on the road and relevant information, such as traffic jams, road repairs or accidents.

Taiwan Patent Publication No. 1674561, titled “real-time traffic notification and formation method”, includes an upload step for uploading the coordinates of at least one fault point to a traffic cloud database after finding the fault point by pedestrian, driver, executive officer or traffic maintenance personnel, and a merge step for merging the coordinates of the fault point received by the traffic cloud database with a map so as to form a road map with the fault point, such that the distribution of the fault points on the road map and the condition of the traffic jam will be uploaded by the pedestrian, driver, executive officer or traffic maintenance personnel without using a fixed vehicle detector or a driving vehicle, which can collect the most complete traffic information at a minimum cost to integrate the most accurate and real-time traffic information.

In Taiwan Patent Publication No. 1674561, the method can instantly report the road conditions and related information for drivers who are connected to get information through the traffic cloud database. However, it is impossible for drivers who are not connected and driving on the roads to immediately learn the road conditions of the roads on which the vehicles are traveling. Accordingly, the inventor of the present invention has devoted himself based on his many years of practical experiences to solve these problems.

### SUMMARY OF THE INVENTION

The primary object of the present invention is to provide a method for detecting a road condition and warning a following vehicle. The method comprises using a road condition detection unit mounted on a vehicle body to detect the road condition in front of the vehicle body to generate a road condition signal; providing a processing unit to generate a display signal after receiving the road condition signal; providing a display unit to generate a warning image on a rear windshield of the vehicle body after receiving the display signal, so as to warn a driver of the following vehicle of the road condition in front of the vehicle body.

Preferably, the road condition detection unit includes a traffic light detector. The road condition signal is the state of a traffic light in front of the vehicle body. The warning image displays the state of the traffic light in front of the vehicle body.

Preferably, the road condition detection unit includes an accelerometer. The road condition signal is a deceleration signal of braking deceleration of the vehicle body. When the speed of the vehicle body is instantaneously reduced more than 3 kilometers per hour within 1 second, the warning image displays that a traffic jam is happening in front of the vehicle body and that the vehicle body is braking and decelerating.

Preferably, the vehicle body has a vehicle abnormality indicator. When the vehicle body is in an abnormal state, the vehicle abnormality indicator is triggered to output a trigger signal to the processing unit. The processing unit receives the trigger signal and controls the display unit to generate a vehicle abnormality image on the rear windshield of the vehicle body to warn the driver of the following vehicle of the abnormal state of the vehicle body.

According to another aspect of the present invention, a car for performing the above-mentioned method is provided. The car comprises a vehicle body, a road condition detection unit, a processing unit, and a display unit. The road condition detection unit is disposed on the vehicle body. The road condition detection unit is configured to detect the road condition in front of the vehicle body and generate a road condition signal. The processing unit is disposed on the vehicle body. The processing unit is configured to generate a display signal after receiving the road condition signal. The display unit is disposed on a rear windshield of the vehicle body. The display unit is configured to generate a warning image after receiving the display signal.

Preferably, the road condition detection unit includes a traffic light detector. The road condition signal is the state of a traffic light in front of the vehicle body. The warning image displays the state of the traffic light in front of the vehicle body.

Preferably, the road condition detection unit includes an accelerometer. The road condition signal is a deceleration signal of braking deceleration of the vehicle body. When the speed of the vehicle body is instantaneously reduced more than 3 kilometers per hour within 1 second, the warning image displays that a traffic jam is happening in front of the vehicle body and that the vehicle body is braking and decelerating.

Preferably, the vehicle body has a vehicle abnormality indicator. When the vehicle body is in an abnormal state, the vehicle abnormality indicator is triggered to output a trigger signal to the processing unit. The processing unit receives the trigger signal and controls the display unit to generate a vehicle abnormality image on the rear windshield of the vehicle body.

Preferably, the display unit is integrated with the rear windshield to form a display screen.

Preferably, the processing unit is a trip computer integrated on the vehicle body.

According to the above technical features, the following effects can be achieved.

1. In the present invention, the road condition detection unit transmits the road condition in front of the car to the display unit through the processing unit. The display unit is the rear windshield of the car. The warning image is displayed on the rear windshield to warn the driver of the following vehicle.

2. The road condition detection unit includes a traffic light detector. The road condition signal is the state of a traffic light in front of the vehicle body. The warning image displays the state of the traffic light in front of the vehicle body.

3. The road condition detection unit includes an accelerometer. The road condition signal is a deceleration signal of braking deceleration of the vehicle body. When the speed of the vehicle body is instantaneously reduced more than 3 kilometers per hour within 1 second, the warning image displays that a traffic jam is happening in front of the vehicle body and that the vehicle body is braking and decelerating.

4. The vehicle body has a vehicle abnormality indicator. When the vehicle body is in an abnormal state, the vehicle abnormality indicator is triggered to output a trigger signal to the processing unit. The processing unit receives the trigger signal and controls the display unit to generate a vehicle abnormality image on the rear windshield of the vehicle body to warn the driver of the following vehicle of the abnormal state of the vehicle body.

5. The display unit is integrated with the rear windshield to form a display screen, and the processing unit is a trip computer integrated on the vehicle body.

### BRIEF DESCRIPTION OF THE DRAWINGS

FIG. 1 is a perspective schematic view of a car used for performing a method detecting a road condition and warning a following vehicle according to the present invention;

FIG. 2 is a flowchart of the method for detecting a road condition and warning a following vehicle according to an embodiment of the present invention;

FIG. 3 is a perspective schematic view showing a traffic light detector used for detecting a front traffic light according to an embodiment of the present invention;

FIG. 4 is a schematic view of a warning image displaying the state of the front traffic light on a rear windshield of the car according to an embodiment of the present invention;

FIG. 5 is a perspective schematic view showing an accelerometer used for sensing deceleration of a front vehicle according to an embodiment of the present invention;

FIG. 6 is a schematic view of a warning image displaying a deceleration signal on the rear windshield of the car according to an embodiment of the present invention;

FIG. 7 is a perspective schematic view showing that the driver of the car triggers a vehicle abnormality indicator and parks the car to the side of the road; and

FIG. 8 is a schematic view of a warning image displaying a vehicle abnormality signal on the rear windshield according to an embodiment of the present invention.

### DETAILED DESCRIPTION OF THE PREFERRED EMBODIMENTS

Embodiments of the present invention will now be described, by way of example only, with reference to the accompanying drawings.

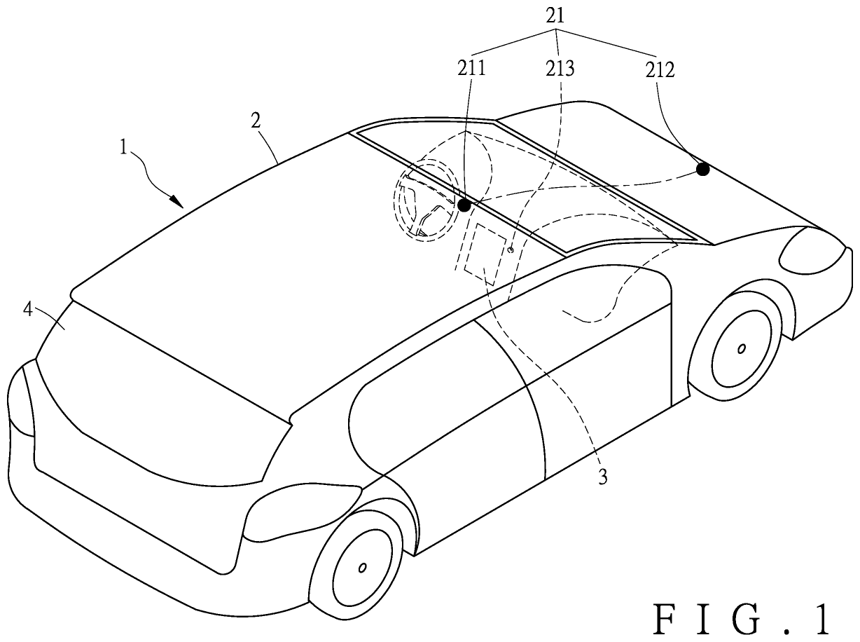

As shown in FIG. 1, a car used for performing a method for detecting a road condition and warning a following vehicle according to an embodiment of the present invention comprises a vehicle body (2), a road condition detection unit (21), a processing unit (3), and a display unit. The road condition detection unit (21) is disposed on the vehicle body (2). The road condition detection unit (21) includes a traffic light detector (211), an accelerometer (212), and a vehicle abnormality indicator (213). The road condition detection unit (21) is configured to detect a road condition in front of the vehicle body (2) and generate a road condition signal. The road condition signal includes the state of a traffic light, a deceleration signal, and a vehicle abnormality signal. The processing unit (3) is disposed on the vehicle body (2). The processing unit (3) is a trip computer integrated on the vehicle body and configured to generate a display signal after receiving the road condition signal. The display unit is disposed on a rear windshield (4) of the vehicle body (2). The display unit is integrated with the rear windshield (4) to form a display screen for generating a warning image after receiving the display signal.

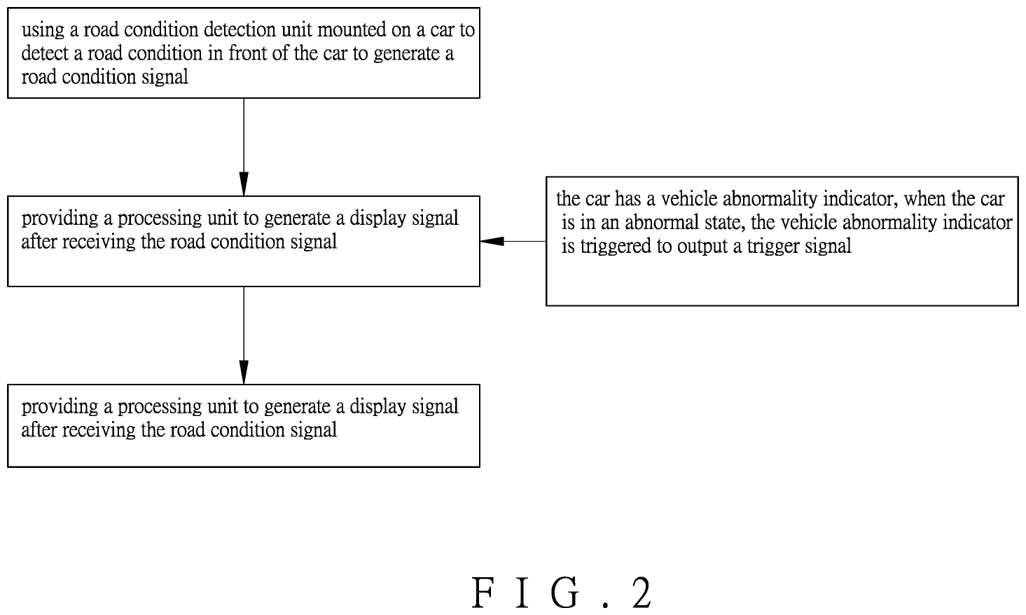

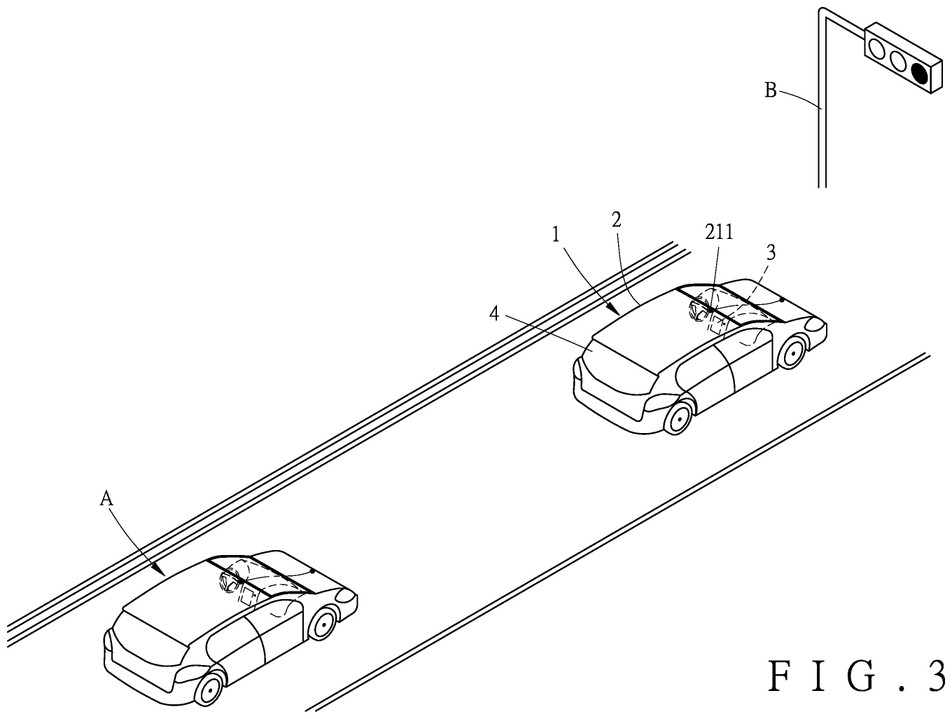

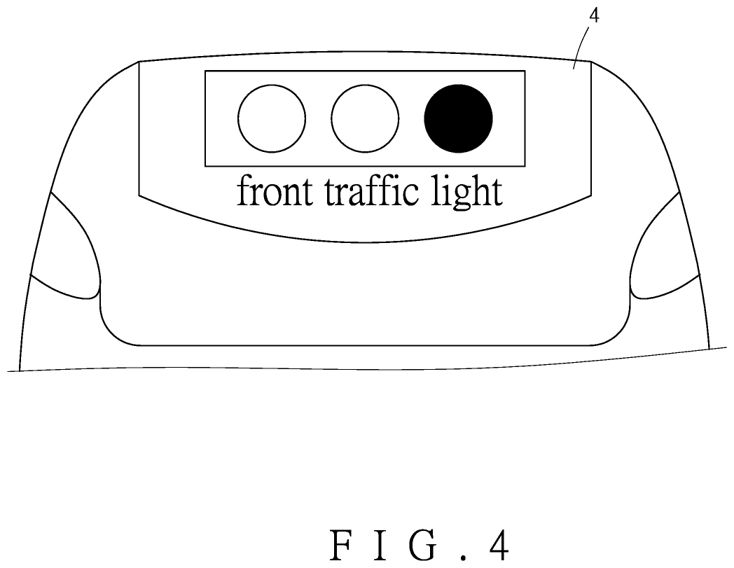

Referring to FIG. 2 through FIG. 4, when the driver drives the car (1) and the traffic light detector (211) on the vehicle body (2) detects the signal of a traffic light (B) in front of the car while driving. The processing unit (3) of the vehicle body (2) processes the road condition signal. The road condition signal is the state of the traffic light in front of the vehicle body (2). The warning image displays the state of the traffic light in front of the vehicle body (2), so that the driver of a following vehicle (A) can learn the state of the traffic light through the rear windshield (4) of the vehicle body (2). More particularly, on roads with multiple curves in mountainous areas, the driver of the following vehicle (A) can learn the state of the traffic light through the rear windshield (4) to display the state of the traffic light. In this way, the driver of the following vehicle (A) can avoid the situation that the front road condition is unknown due to a turn on a curved road.

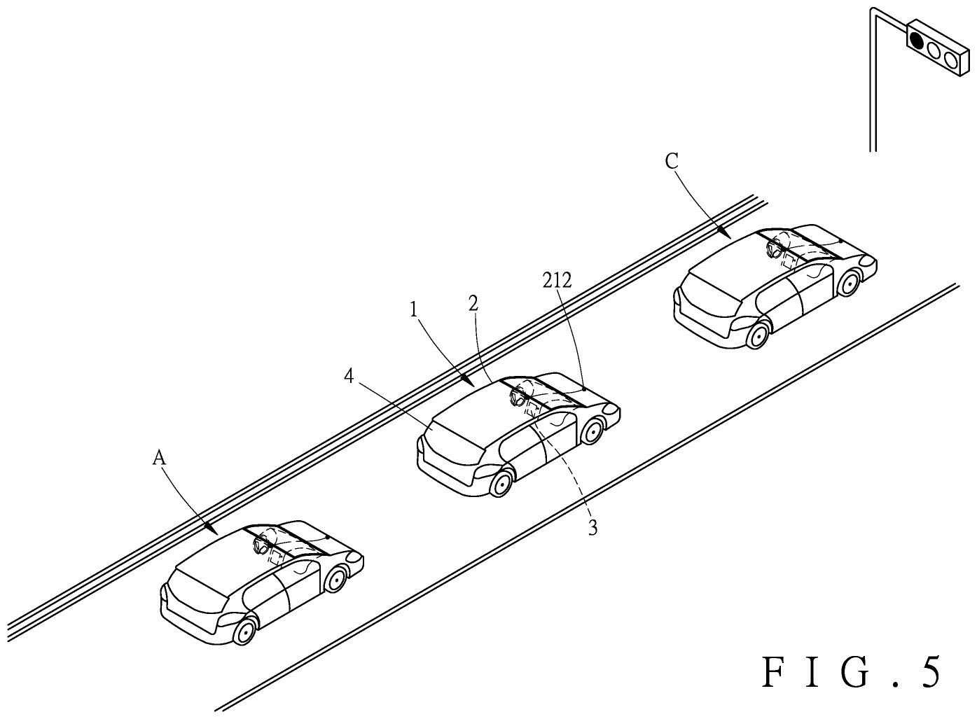

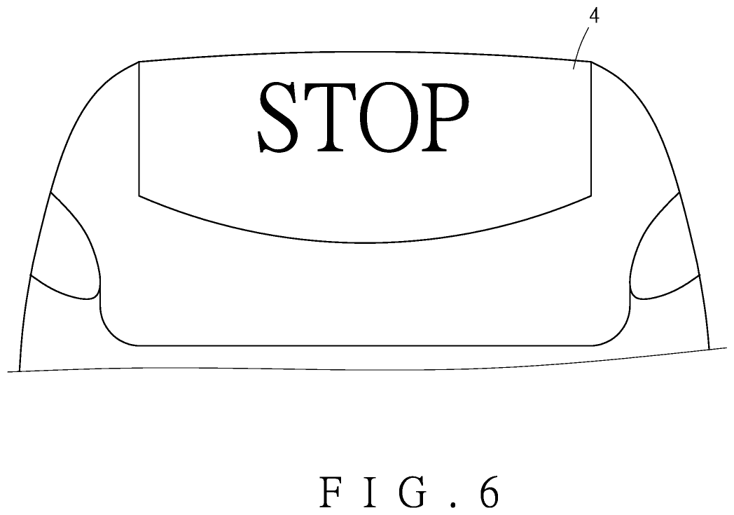

Please refer to FIG. 2, FIG. 5 and FIG. 6. When the driver drives the car (1) and the accelerometer (212) on the vehicle body (2) detects a front vehicle (C) stuck in a traffic jam, the processing unit (3) of the vehicle body (2) processes the road condition signal. The road condition signal is a deceleration signal of braking deceleration of the vehicle body (2). When the speed of the vehicle body is instantaneously reduced more than 3 kilometers per hour within 1 second, the warning image displays the traffic jam in front of the vehicle body (2), so that the driver of the following vehicle (A) can learn the front traffic jam through the rear windshield (4) of the vehicle body (2). More particularly, on high-speed driving conditions, the driver of the following vehicle (A) can learn the front traffic jam through the rear windshield (4) to display the state of the front traffic jam. In this way, the driver of the following vehicle (A) can learn the front traffic jam and reduce the driving speed early to avoid emergency braking of the following vehicle to cause a car accident.

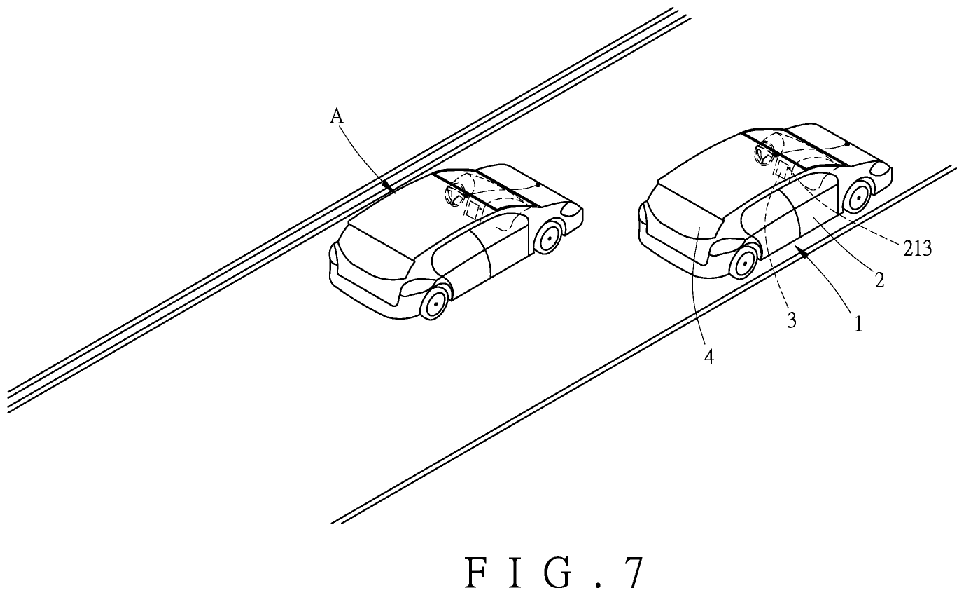

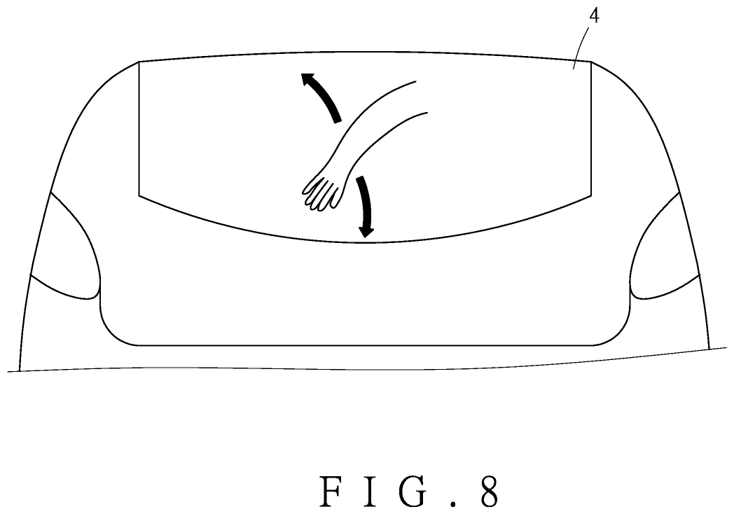

Please refer to FIG. 2, FIG. 7 and FIG. 8. When the driver drives the car (1) and the vehicle body (2) of the car (1) is in an abnormal state, the driver of the car (1) may trigger the vehicle abnormality indicator (213) to output a trigger signal to the processing unit (3). The processing unit (3) receives the trigger signal and controls the display unit to generate a vehicle abnormality image on the rear windshield (4) of the vehicle body (2) to warn the driver of the following vehicle (A) of the abnormal state of the vehicle body (2). Through the vehicle abnormality image on the rear windshield (4), the driver of the following vehicle (A) can learn that the car (1) is in an abnormal state, so as to overtake or keep a certain distance from the car (1). The driver of the car (1) can park the car (1) to the side of the road to reduce accidents.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A method for detecting a road condition and warning a following vehicle, comprising:
using a road condition detection unit mounted on a vehicle body to detect the road condition in front of the vehicle body to generate a road condition signal;
providing a processing unit to generate a display signal after receiving the road condition signal;
providing a display unit to generate a warning image on a rear windshield of the vehicle body after receiving the display signal, so as to warn a driver of the following vehicle of the road condition in front of the vehicle body.

2. The method as claimed in claim 1, wherein the road condition detection unit includes a traffic light detector, the road condition signal is the state of a traffic light in front of the vehicle body, and the warning image displays the state of the traffic light in front of the vehicle body.

3. The method as claimed in claim 1, wherein the road condition detection unit includes an accelerometer, the road condition signal is a deceleration signal of braking deceleration of the vehicle body, when the speed of the vehicle body is instantaneously reduced more than 3 kilometers per hour within 1 second, the warning image displays that a traffic jam is happening in front of the vehicle body and that the vehicle body is braking and decelerating.

4. The method as claimed in claim 1, wherein the vehicle body has a vehicle abnormality indicator, when the vehicle body is in an abnormal state, the vehicle abnormality indicator is triggered to output a trigger signal to the processing unit, the processing unit receives the trigger signal and controls the display unit to generate a vehicle abnormality image on the rear windshield of the vehicle body to warn the driver of the following vehicle of the abnormal state of the vehicle body.

5. A car for performing the method as claimed in claim 1, comprising:
a vehicle body;
a road condition detection unit, disposed on the vehicle body, the road condition detection unit being configured to detect the road condition in front of the vehicle body and generate a road condition signal;
a processing unit, disposed on the vehicle body, the processing unit being configured to generate a display signal after receiving the road condition signal;
a display unit, disposed on a rear windshield of the vehicle body, the display unit being configured to generate a warning image after receiving the display signal.

6. The car as claimed in claim 5, wherein the road condition detection unit includes a traffic light detector, the road condition signal is the state of a traffic light in front of the vehicle body, and the warning image displays the state of the traffic light in front of the vehicle body.

7. The car as claimed in claim 5, wherein the road condition detection unit includes an accelerometer, the road condition signal is a deceleration signal of braking deceleration of the vehicle body, when the speed of the vehicle body is instantaneously reduced more than 3 kilometers per hour within 1 second, the warning image displays that a traffic jam is happening in front of the vehicle body and that the vehicle body is braking and decelerating.

8. The car as claimed in claim 5, wherein the vehicle body has a vehicle abnormality indicator, when the vehicle body is in an abnormal state, the vehicle abnormality indicator is triggered to output a trigger signal to the processing unit, the processing unit receives the trigger signal and controls the display unit to generate a vehicle abnormality image on the rear windshield of the vehicle body.

9. The car as claimed in claim 5, wherein the display unit is integrated with the rear windshield to form a display screen.

10. The car as claimed in claim 5, wherein the processing unit is a trip computer integrated on the vehicle body.
